(19) United States
(12) Patent Application Publication
(10) Pub. No.: US 2012/0231381 A1
(43) Pub. Date: Sep. 13, 2012

(54) ELECTROSTATIC IMAGE DEVELOPING TONER, TONER CARTRIDGE, ELECTROSTATIC IMAGE DEVELOPER, PROCESS CARTRIDGE AND IMAGE FORMING APPARATUS

(75) Inventors: Katsuyuki KITAJIMA, Kanagawa (JP); Yutaka SAITO, Kanagawa (JP); Masahiro TAKAGI, Kanagawa (JP)

(73) Assignee: FUJI XEROX CO., LTD., Tokyo (JP)

(21) Appl. No.: 13/214,793

(22) Filed: Aug. 22, 2011

(30) Foreign Application Priority Data
Mar. 8, 2011 (JP) 2011-050410

(51) Int. Cl. G03G 9/00; G03G 21/18; G03G 15/08

(52) U.S. Cl. 430/105; 399/111; 399/252; 430/109.1

(57) ABSTRACT

An electrostatic image developing toner including: a toner particle containing a coloring agent and a binder resin; and an external additive having a volume average particle diameter of from 70 nm to 400 nm, an average circularity of from 0.5 to 0.9 and a standard deviation of circularity of not more than 0.2.

### CROSS-REFERENCE TO RELATED APPLICATION(S)

The present application claims priority from Japanese Patent Application No. 2011-050410 filed on Mar. 8, 2011, the entire content of which is incorporated herein by reference.

### BACKGROUND

1. Field

The present invention relates to an electrostatic image developing toner, a toner cartridge, an electrostatic image developer, a process cartridge and an image forming apparatus.

2. Description of the Related Art

In recent years, because of development of instruments and substantiality of communication network in the information society, an electrophotographic process is widely utilized for not only copying machines but network printers in an office, printers for personal computers, printers for on-demand printing and the like, and high image quality, high speed, high reliability, size reduction, weight reduction and energy saving are being strongly required more and more irrespective of black-and-white or color printing.

In the electrophotographic process, in general, a fixed image is formed through plural steps including electrically forming a latent image (electrostatic image) on a photoreceptor (latent image holding member) utilizing a photoconductive material by various means, developing this latent image with a toner, transferring a toner image on the photoreceptor onto a transfer-receiving material such as paper via or not via an intermediate transfer material, and then fixing this transferred image onto the transfer-receiving material.

### SUMMARY

(1) An electrostatic image developing toner including: a toner particle containing a coloring agent and a binder resin; and an external additive on the toner particle, having a volume average particle diameter of from 70 nm to 400 nm, an average circularity of from 0.5 to 0.9 and a standard deviation of circularity of not more than 0.2.

### BRIEF DESCRIPTION OF DRAWINGS

Exemplary embodiments of the present invention will be described in detail based on the following figures, wherein:

FIG. 1 is a diagrammatic configuration view showing an example of an image forming apparatus according to an exemplary embodiment of the invention;

FIG. 2 is a diagrammatic configuration view showing an example of a process cartridge according to an exemplary embodiment of the invention.

### DETAILED DESCRIPTION OF EXEMPLARY EMBODIMENTS

Exemplary embodiments of an electrostatic image developing toner, a toner cartridge, an electrostatic image developer, a process cartridge and an image forming apparatus according to the invention are hereunder described in detail.

### <Electrostatic Image Developing Toner>

The electrostatic image developing toner according to the present exemplary embodiment (hereinafter also referred to as “toner according to the present exemplary embodiment”) includes a toner particle containing at least a binder resin, a release agent and a coloring agent; and an external additive having a volume average particle diameter of from 70 nm to 400 nm, an average circularity of from 0.5 to 0.9 and a standard deviation of circularity of not more than 0.2.

For the purpose of obtaining a spacer effect, a spherical large-sized external additive is hitherto used. But, when the external additive is spherical, for example, when a developer is stirred within a developing unit, there may be the case where transfer of the external additive into a carrier is vigorous, and as a result, charge of the toner is lowered. In the present exemplary embodiment, an external additive which is made heterogeneous so as to have an average circularity of from 0.5 to 0.9 and which has a narrow distribution of shape (having a standard deviation of circularity of not more than 0.2 and having a low content of a spherical external additive component) is used. By using such an external additive, a number of contact points between the external additive and the toner surface increases, whereby the transfer of the external additive into the carrier is suppressed.

When printing with a high image density continues, a toner in a state close to an initial state is always intermingled into a developing machine. Namely, the external additive which is embedded with time and fixed onto the toner surface to some extent is not embedded into the toner yet in an initial state, and therefore, the external additive is in a state where it is easy to transfer into a carrier. However, by using the heterogenized external additive according to the present exemplary embodiment, transfer of the external additive into a carrier may be suppressed. When transfer of the external additive into a carrier frequently occurs, a charge ability of the carrier is impaired, and the toner is lowly electrified. However, by using the heterogeneous external additive, as described previously, transfer of the external additive into the carrier may be suppressed, and therefore, the toner is not lowly electrified. As a result, in-apparatus contamination is suppressed.

In particular, since an absolute humidity is high under a high-temperature and high-humidity condition, a water content in air is high, charge of the toner is easy to become low, and in-apparatus contamination (cloud) is easily generated due to a slight variation of charge. By using the toner according to the present exemplary embodiment, the in-apparatus contamination may be prevented even in a high-temperature and high-humidity environment.

Incidentally, the high-temperature and high-humidity environment as referred to in the present exemplary embodiment refers to an environment at a temperature of 28° C. or higher and a humidity of 80% RH or more.

The toner according to the present exemplary embodiment includes a toner particle containing at least a binder resin, a release agent and a coloring agent and the above-specified external additive. The components constituting the toner according to the present exemplary embodiment are hereunder described.

### (External Additive)

First of all, the external additive is described.

As described previously, as the external additive, an external additive having a volume average particle diameter of from 70 nm to 400 nm, an average circularity of from 0.5 to 0.9 and a standard deviation of circularity of not more than 0.2 is used.

### —Volume Average Particle Diameter—

The volume average particle diameter of the external additive is required to be from 70 nm to 400 nm. When the volume average particle diameter of the external additive is less than 70 nm, there may be the case where the external additive is easily embedded into the toner, so that a spacer effect which the external additive originally has is not obtainable. On the other hand, when the volume average particle diameter of the external additive exceeds 400 nm, detachment with time of the external additive from the toner is frequently found; and even when the heterogeneous external additive is used, the transfer amount into the carrier increases, and as a result, there may be the case where the charge distribution becomes broad, the toner is lowly electrified, and in-apparatus contamination is generated. The volume average particle diameter of the external additive is desirably from 140 nm to 300 nm, and more desirably from 210 nm to 300 nm.

Here, with respect to the volume average particle diameter of the external additive, the toner particle surface is observed, and 100 external additive particles are observed. The image of the observed toner particle surface is analyzed using an image processing analysis software, WinROOF (manufactured by Mitani Corporation), thereby calculating the volume average particle diameter of the external additive.

### —Average Circularity—

The average circularity of the external additive is required to be from 0.5 to 0.9. When the average circularity of the external additive is less than 0.5, the external additive becomes a particle having a large shape with a large aspect ratio, and there may be the case where when a mechanical load is applied, the external additive is easily broken. Also, there may be the case where it is difficult to stably produce an external additive having an average circularity of less than 0.5. On the other hand, when the average circularity of the external additive exceeds 0.9, since the shape of the external additive is close to a sphere, there may be the case where the transfer amount into the carrier increases. The average circularity of the external additive is desirably from 0.60 to 0.85, and more preferably from 0.65 to 0.80.

The external additive having an average circularity falling within the foregoing range has a lower circularity than that of generally used external additives. In such a heterogeneous external additive, a number of contact points with the toner surface increases, so that the transfer of the external additive into the carrier is suppressed.

The average circularity is a value obtained by image analyzing 100 external additives (particles), determining an average circularity of each of the photographed external additive particles according to the following expression and averaging the determined values (the same as the calculation of the volume average particle diameter).

$$\begin{matrix}Circularity = \frac{( Circle \text{-} corresponding diameter circumferential length )}{( Circumferential length )} \\ = [ 2 \times {( A π )}^{1 / 2} ] / PM\end{matrix}$$

In the foregoing expression, A represents a projected area of the external additive particle; and PM represents a circumferential length of the external additive particle.

The case where the average circularity is 1.0 means that the particle is a true sphere, and this numerical value becomes low, a degree of heterogeneity meaning the existence of irregularities on the outer circumference becomes large.

### —Standard Deviation of Circularity—

The standard deviation of circularity of the external additive is required to be not more than 0.2. When the standard deviation of circularity of the external additive exceeds 0.2, a proportion of a spherical external additive occupying in the whole of the external additive is high. Since the spherical external additive is easy to transfer into the carrier, when an external additive having a standard deviation of circularity exceeding 0.2 is used, the transfer of the external additive into the carrier is easy to occur.

The standard deviation of circularity of the external additive is calculated by means of image analysis at the time of measuring the average circularity.

### —Material Quality—

In view of the fact that the effects to be brought by the toner according to the present exemplary embodiment are those which are mechanically brought by the volume average particle diameter, average circularity and standard deviation of circularity of the external additive, the external additive is not particularly limited with respect to its material quality so far as it satisfies the foregoing ranges regarding the volume average particle diameter, average circularity and standard deviation of circularity, and known materials are applicable. The material of the external additive which is applicable is hereunder described.

Examples of the external additive include those which are well-known, such as inorganic particles and organic particles. Specific examples of the inorganic particle include all of particles which are in general used as an external additive for the toner surface, such as silica (for example, fumed silica, sol-gel silica, etc.), alumina, titania, zinc oxide, tin oxide, iron oxide, calcium carbonate, magnesium carbonate, tricalcium phosphate, cerium oxide, and tin oxide; and specific examples of the organic particle include all of particles which are in general used as an external additive for the toner surface, such as vinyl based resins, polyester resins, silicone resins and fluorine-containing resins.

### —Preparation Method—

As described previously, any material qualities are useful for the external additive so far as they fall within the foregoing ranges regarding the average circularity and the like. As an example of the external additive, a preparation method of sol-gel silica which satisfies the foregoing numerical value ranges regarding the average circularity and the like is hereunder described.

The preparation method of sol-gel silica includes a step of preparing an alkaline catalyst solution containing an alkaline catalyst in a concentration of from 0.6 mol/L to 0.87 mol/L in an alcohol-containing solvent (also referred to as an “alkaline catalyst solution preparing step”); and a step of supplying a tetraalkoxysilane into the alkaline catalyst solution and also supplying an alkaline catalyst in an amount of from 0.1 mol to 0.4 mol per mole of the total supply amount of the tetraalkoxysilane to be supplied per minute (also referred to as a “particle forming step”).

Namely, this preparation method is concerned with a method of supplying a tetraalkoxysilane as a raw material and separately an alkaline catalyst as a catalyst in the foregoing relations, respectively in the presence of an alcohol containing the alkaline catalyst in the foregoing concentration, thereby causing a reaction of the tetraalkoxysilane to form a silane particle.

In the present preparation method of a silica particle, a silica particle which is small in the generation of a coarse aggregate and low in the circularity is obtained by the foregoing measure. While a reason for this is not revealed yet, it may be considered that this is caused due to the following reason.

First of all, when the alkaline catalyst solution containing the alkaline catalyst is prepared in the alcohol-containing solvent, and the tetraalkoxysilane and the alkaline catalyst are supplied, respectively in this solution, the tetraalkoxysilane supplied in the alkaline catalyst solution reacts to form a nucleus particle. At that time, when the alkaline catalyst concentration in the alkaline catalyst solution falls within the foregoing range, it may be considered that a nucleus article having a low circularity is formed while suppressing the formation of a coarse aggregate such as a secondary aggregate. It may be considered that this is caused due to the fact that though in addition to the catalytic action, the alkaline catalyst has an action to coordinate to the surface of the nucleus particle to be formed, thereby contributing to the shape and dispersion stability of the nucleus particle, when its amount falls within the foregoing range, the alkaline catalyst does not uniformly coat the surface of the nucleus particle (namely, the alkaline catalyst is unevenly distributed and attaches onto the surface of the nucleus particle), and therefore, while the dispersion stability of the nucleus particle is kept, partial deviations in surface tension and chemical affinity of the nucleus particle are caused, so that the nucleus particle having a low circularity is formed.

Then, when the supply of each of the tetraalkoxysilane and the alkaline catalyst is continued, the formed nucleus particle grows due to the reaction of the tetraalkoxysilane, whereby a silane particle is obtained. Here, it may be considered that by performing the supply of each of the tetraalkoxysilane and the alkaline catalyst while keeping the supply amounts thereof in the foregoing relations, the nucleus particle having a low circularity causes particle growth with its heterogeneous shape being kept while suppressing the formation of a coarse aggregate such as a secondary aggregate, and as a result, a silica particle having a low circularity is formed. This is because it may be considered that by allowing the supply amounts of the tetraalkoxysilane and the alkaline catalyst to satisfy the foregoing relations, the partial deviations in tension and chemical affinity on the surface of the nucleus particle are kept while keeping dispersion of the nucleus particle, so that the particle growth of the nucleus particle is caused while keeping the heterogeneous shape.

In the light of the above, in the present preparation method of a silica particle, it may be considered that a silica particle which is small in the generation of a coarse aggregate and low in the circularity is obtained.

Here, it may be considered that the supply amount of the tetraalkoxysilane is related to the particle size distribution or the circularity of the silica particle. It may be considered that by regulating the supply amount of the tetraalkoxysilane to 0.002 mol/(mol·min) or more and less than 0.0055 mol/(mol·min), a contact probability between the tetraalkoxysilane added dropwise and the nucleus particle is decreased, and before a reaction between the tetraalkoxysilanes with each other occurs, the tetraalkoxysilane is supplied into the nucleus particle without a deviation. In consequence, it may be considered that the reaction between the tetraalkoxysilane and the nucleus particle may be caused without a deviation. As a result, it may be considered that a silica particle with a narrow distribution width may be produced while suppressing scattering of the particle growth.

Incidentally, it may be considered that the volume average particle diameter of the silica particle is dependent upon the total supply amount of the tetraalkoxysilane.

Also, in the present preparation method of a silica particle, it may be considered that a nucleus particle in a heterogeneous shape is formed, and the nucleus particle is allowed to grow while keeping this heterogeneous shape, whereby the silica particle is formed. Therefore, it may be considered that a silica particle in a heterogeneous shape, which is strong against a mechanical load and is hardly broken, is obtained.

Also, in the present preparation method of a silica particle, it may be considered that the particle is allowed to grow in a state where the formed nucleus particle in a heterogeneous shape keeps its heterogeneous shape, whereby the silica particle is obtained. Therefore, it may be considered that a silica particle which is strong against a mechanical load and is hardly broken is obtained.

Also, in the present preparation method of a silica particle, in view of the fact that the particle formation is performed by supplying each of the tetraalkoxysilane and the alkaline catalyst into the alkaline catalyst solution and causing a reaction of the tetraalkoxysilane, as compared with the case of producing a silica particle in a heterogeneous shape by a conventional sol-gel method, a total amount of the used alkaline catalyst is small, and as result, an omission of a removal step of the alkaline catalyst is realized. This is advantageous especially in the case where a silica particle is applied to products in which a high purity is required.

Next, the alkaline catalyst solution preparing step is described.

In the alkaline catalyst solution preparing step, an alcohol-containing solvent is prepared, to which is then added an alkaline catalyst to prepare an alkaline catalyst solution.

The alcohol-containing solvent may be a solvent composed of an alcohol solely, or may be a mixed solvent of an alcohol with other solvent such as water; ketones (for example, acetone, methyl ethyl ketone, methyl isobutyl ketone, etc.); cellosolves (for example, methyl cellosolve, ethyl cellosolve, butyl cellosolve, cellosolve acetate, etc.); and ethers (for example, dioxane, tetrahydrofuran, etc.), if desired.

In the case of a mixed solvent, it would be better that an amount of the alcohol relative to other solvent is 80% by mass or more (desirably 90% by mass or more).

Incidentally, examples of the alcohol include lower alcohols such as methanol and ethanol.

Meanwhile, the alkaline catalyst is a catalyst for accelerating the reaction (for example, a hydrolysis reaction or a condensation reaction) of the tetraalkoxysilane, and examples thereof include basic catalysts such as ammonia, urea, a monoamine and a quaternary ammonium salt. Of these, ammonia is especially desirable.

A concentration (content) of the alkaline catalyst is from 0.6 mol/L to 0.87 mol/L, desirably from 0.63 mol/L to 0.78 mol/L, and more desirably from 0.66 mol/L to 0.75 mol/L.

When the concentration of the alkaline catalyst is less than 0.6 mol/L, dispersibility of a formed nucleus particle in a growth process of the nucleus particle becomes instable, so that there is a concern that a coarse aggregate such as a secondary aggregate is formed, or gelation occurs, thereby deteriorating the particle size distribution.

On the other hand, when the concentration of the alkaline catalyst is more than 0.87 mol/L, stability of a formed nucleus particle becomes excessive, a nucleus particle in a true spherical shape is formed, and it is difficult to obtain a nucleus particle in a heterogeneous shape having an average circularity of not more than 0.90.

Incidentally, the concentration of the alkaline catalyst is a concentration relative to the alkaline catalyst solution (the alkaline catalyst +the alcohol-containing solvent).

Next, the particle forming step is described.

The particle forming step is a step of supplying each of a tetraalkoxysilane and an alkaline catalyst into the alkaline catalyst solution to subject the tetraalkoxysilane to a reaction (for example, a hydrolysis reaction or a condensation reaction) in the alkaline catalyst solution, thereby forming a silica particle.

In this particle forming step, at the beginning of supply of the tetraalkoxysilane, a nucleus particle is formed by the reaction of the tetraalkoxysilane (nuclear particle forming stage), and thereafter, the silica particle is formed through growth of this nucleus particle (nucleus particle growing stage).

Examples of the tetraalkoxysilane which is supplied into the alkaline catalyst solution include tetramethoxysilane, tetraethoxysilane, tetrapropoxysilane and tetrabutoxysilane. However, from the standpoints of controllability of the reaction rate, the shape, particle diameter and particle size distribution of the obtained silica particle, and the like, tetramethoxysilane or tetraethoxysilane is desirable.

A supply amount of the tetraalkoxysilane is from 0.002 mol/(mol·min) to 0.0055 mol/(mol·min) relative to the alcohol in the alkaline catalyst solution.

This means that the tetraalkoxysilane is supplied in a supply amount of from 0.002 mol to 0.0055 mol per minute relative to one mole of the alcohol used in the step of preparing an alkaline catalyst solution.

Incidentally, though the particle diameter of the silica particle varies with the kind of the tetraalkoxysilane or the reaction condition, for example, by regulating a total supply amount of the tetraalkoxysilane used for the reaction of particle formation to 0.756 mol or more per liter of the silica particle dispersion liquid, a primary particle having a particle diameter of 70 nm or more is obtained, and by regulating a total supply amount of the tetraalkoxysilane used for the reaction of particle formation to not more than 4.4 mol per liter of the silica particle dispersion liquid, a primary particle having a particle diameter of not more than 400 nm is obtained.

When the supply amount of the tetraalkoxysilane is less than 0.002 mol/(mol·min), a contact probability between the tetraalkoxysilane added dropwise and the nucleus particle is more decreased. However, it takes a long period of time for completion of the dropwise addition of the total supply amount of the tetraalkoxysilane, and the preparation efficiency is poor.

When the supply amount of the tetraalkoxysilane exceeds 0.0055 mol/(molmin), it may be considered that before the tetraalkoxysilane added dropwise and the nucleus particle react with each other, a reaction between tetraalkoxysilanes with each other is caused. For that reason, in view of the fact that a deviation of the supply of the tetraalkoxysilane into the nucleus particle is accelerated, thereby bringing scattering of the particle growth, there may be the case where the distribution width of shape distribution is expanded, so that it becomes difficult to produce silica having a standard deviation of circularity of not more than 0.2.

The supply amount of the tetraalkoxysilane is desirably from 0.002 mol/(mol·min) to 0.0045 mol/(mol·min), and more desirably from 0.002 mol/(mol·min) to 0.0035 mol/(mol·min).

Meanwhile, examples of the alkaline catalyst which is supplied into the alkaline catalyst solution include those exemplified above. Though this alkaline catalyst to be supplied may be the same as or different from the alkaline catalyst previously contained in the alkaline catalyst solution, it would be better to use the alkaline catalyst of the same kind.

A supply amount of the alkaline catalyst is from 0.1 mol to 0.4 mol, desirably from 0.14 mol to 0.35 mol, and more desirably from 0.18 mol to 0.30 mol per mole of the total supply amount of the tetraalkoxysilane to be supplied per minute.

When the supply amount of the alkaline catalyst is less than 0.1 mol per mole of the total supply amount of the tetraalkoxysilane to be supplied per minute, dispersibility of a formed nucleus particle in a growth process of the formed nucleus particle becomes instable, so that there may be the case where a coarse aggregate such as a secondary aggregate is formed, or gelation occurs, thereby deteriorating the particle size distribution.

On the other hand, when the supply amount of the alkaline catalyst is more than 0.4 mol, stability of a formed nucleus particle becomes excessive, and there may be the case where even when a nucleus particle having a low circularity is formed at a nucleus particle forming stage, the nucleus particle grows in a spherical shape at its nucleus particle growth stage, so that a silica particle having a low circularity is not obtained.

Here, in the particle forming step, each of the tetraalkoxysilane and the alkaline catalyst is supplied into the alkaline catalyst solution. The supply method may be a mode of continuously supplying them, or a mode of intermittently supplying them.

Also, in the particle forming step, a temperature in the alkaline catalyst solution (temperature at the time of supply) may be, for example, in the range of from 5° C. to 50° C. and is desirably in the range of from 15° C. to 40° C.

The silica particle is obtained through the foregoing steps. Though the silica particle obtained in this state is obtained in a state of a dispersion liquid, it may be used as a silica particle dispersion liquid as it is, or may be taken out and used as a powder of the silica particle after removing the solvent.

In the case of using the silica particle as a silica particle dispersion liquid, a solids concentration of the silica particle may be adjusted upon being diluted with water or an alcohol or being concentrated, if desired. Also, the silica particle dispersion liquid may be used upon being subjected to solvent substitution with a water-soluble organic solvent such as other alcohol, an ester and a ketone.

Examples of a method of removing the solvent of the silica particle dispersion liquid include known methods such as (1) a method of performing drying using a vacuum dryer, a tray type dryer, etc. after removing the solvent by means of filtration, centrifugation, distillation or the like; and (2) a method of directly drying the slurry using a fluidized layer dryer, a spray dryer or the like. Though a drying temperature is not particularly limited, it is desirably not higher than 200° C. When the drying temperature is higher than 200° C., bonding among primary particles to each other or generation of a coarse particle due to condensation of a silanol group remaining on the surface of the silica particle is easy to occur.

It would be better that if desired, the dried silica particle is crushed and sieved, thereby removing a coarse particle or aggregate. Though a crushing method is not particularly limited, it is, for example, performed by a dry type pulverizer such as a jet mill, a vibration mill, a ball mill and a pin mill. A sieving method is, for example, performed using a known device such as a vibration sieve and a wind force sieve.

The silica particle obtained by the present preparation method of a silica particle may be used after subjecting the surface of the silica particle to a hydrophobic treatment with a hydrophobic treatment agent.

Examples of the hydrophobic treatment agent include known organosilicon compounds having an alkyl group (for example, a methyl group, an ethyl group, a propyl group, a butyl group, etc.). Specific examples thereof include silazane compounds (for example, silane compounds such as methyltrimethoxysilane, dimethyldimethoxysilane, trimethylchlorosilane and trimethylmethoxysilane, hexamethyldisilazane, tetramethyldisilazane, etc.). The hydrophobic treatment agent may be used solely or in combination of plural kinds thereof.

Of these hydrophobic treatment agents, organosilicon compounds having a trimethyl structure, such as trimethylmethoxysilane and hexamethyldisilazane, are suitable.

Though a use amount of the hydrophobic treatment agent is not particularly limited, in order to obtain a hydrophobic effect, it is, for example, from 1% by mass to 100% by mass, and desirably from 5% by mass to 80% by mass relative to the silica particle.

Examples of a method of obtaining a hydrophobic silica particle dispersion liquid having been subjected to a hydrophobic treatment with a hydrophobic treatment agent include a method of obtaining a hydrophobic silica particle dispersion liquid by adding a necessary amount of a hydrophobic treatment agent to a silica particle dispersion liquid and allowing the mixture to react with stirring at a temperature ranging from 30° C. to 80° C., thereby subjecting the silica particle to a hydrophobic treatment. When this reaction temperature is a lower temperature than 30° C., the hydrophobic reaction hardly proceeds, whereas when the reaction temperature is a temperature exceeding 80° C., there may be the case where gelation of the dispersion liquid by self-condensation of the hydrophobic treatment agent or aggregation among silica particles to each other is easy to occur.

Meanwhile, examples of a method of obtaining a powdered hydrophobic silica particle include a method in which a hydrophobic silica particle dispersion liquid is obtained by the foregoing method and then dried by the foregoing method, thereby obtaining a powder of a hydrophobic silica particle; a method in which a silica particle dispersion liquid is dried to obtain a powder of a hydrophilic silica particle, which is then subjected to a hydrophobic treatment by the addition of a hydrophobic treatment agent, thereby obtaining a powder of a hydrophobic silica powder; and a method in which after obtaining a hydrophobic silica particle dispersion liquid, the hydrophobic silica particle dispersion liquid is dried to obtain a powder of a hydrophobic silica particle, which is further subjected to a hydrophobic treatment by the addition of a hydrophobic treatment agent, thereby obtaining a powder of a hydrophobic silica particle.

Here, examples of a method of subjecting a powdered specific silica particle to a hydrophobic treatment include a method in which a powdered hydrophilic silica particle is stirred within a treatment tank such as a Henschel mixer and a fluidized bed, a hydrophobic treatment agent is added thereto, and the inside of the treatment tank is heated to gasify the hydrophobic treatment agent, thereby allowing it to react with a silanol group on the surface of the powdered specified silica particle. Though a treatment temperature is not particularly limited, it may be, for example, from 80° C. to 300° C., and it is desirably from 120° C. to 200° C.

According to the present preparation method of a silica particle, a silica particle having not only a low average circularity but a narrow standard deviation of circularity as compared with those of general silicas is obtainable.

An addition amount of the external additive is desirably from 0.5 parts by mass to 5.0 parts by mass, more desirably from 0.7 parts by mass to 4.0 parts by mass, and still more desirably from 0.9 parts by mass to 3.5 parts by mass based on 100 parts by mass of a toner particle as described later.

### (Toner Particle)

Next, the toner particle is described.

The toner particle is constituted so as to contain at least a binder resin, a release agent and a coloring agent, and if desired, it may be constituted so as to further contain other additives.

### —Binder Resin—

The binder resin is described.

As the binder resin, there is exemplified an amorphous resin, and an amorphous resin and a crystalline resin may also be used in combination.

Examples of the binder resin include a polyester resin and a vinyl based resin.

The polyester resin is, for example, synthesized from a polyvalent carboxylic acid component and a polyhydric alcohol component.

Incidentally, as the polyester resin, commercially available products may be used, or synthesized materials may be used.

The polyester resin is not particularly limited with respect to a preparation method thereof and is produced by a general polyester polymerization method of allowing an acid component and an alcohol component to react with each other. Examples of the polyester polymerization method include a direct polycondensation method and an ester interchange method. The polyester resin is produced by varying the polymerization method depending upon the kinds of monomers.

The preparation of a polyester resin is performed at a polymerization temperature ranging from 180° C. to 230° C., and if desired, the inside of the reaction system is made under reduced pressure, thereby performing the reaction while removing water or an alcohol generated at the time of condensation. In the case where the monomers are insoluble or incompatible at the reaction temperature, the monomers may be made soluble by the addition of a high-boiling solvent as a dissolution auxiliary agent. In the polycondensation reaction, the preparation of a polyester resin is performed while distilling off the dissolution auxiliary solvent. In a copolymerization reaction, in the case where a monomer which is poor in compatibility is present, it would be better that after the monomer which is poor in compatibility is previously condensed with an acid or an alcohol which is scheduled to be subjected to polycondensation with the subject monomer, the resultant is subjected to polycondensation together with a major component.

In the case where the binder resin has a melting temperature, the melting temperature is desirably from 50° C. to 100° C., and more desirably from 60° C. to 80° C. Also, in the case where the binder resin has a glass transition temperature, the glass transition temperature is desirably from 35° C. to 100° C., and more desirably from 50° C. to 80° C.

The melting temperature of the binder resin as referred to herein means a value obtained by determining an endothermic peak obtained by the differential scanning calorimetry (DSC) as a peak temperature. Also, though there may be the case where the binder resin has plural endothermic peaks, in the present exemplary embodiment, a maximum peak is considered as the melting temperature.

Also, the glass transition temperature of the binder resin as referred to herein is determined as a peak temperature of an endothermic peak obtained by the differential scanning calorimetry (DSC).

The polyester resin may be produced by subjecting the foregoing polyhydric alcohol and polyvalent carboxylic acid to a condensation reaction according to the usual way. For example, the polyester resin may be produced by charging the foregoing polyhydric alcohol and polyvalent carboxylic acid and optionally, a catalyst and blending them in a reaction vessel equipped with a thermometer, a stirrer and a flow-down type condenser; heating the mixture at from 150° C. to 250° C. in the presence of an inert gas (for example, a nitrogen gas, etc.); continuously removing a low-molecular weight compound formed as a by-product out the reaction system; and stopping the reaction at a point of time when the reaction system reaches a specified acid value, followed by cooling to obtain a desired reaction product.

Here, with respect to the binder resin, a weight average molecular weight (Mw) is desirably from 5,000 to 1,000,000, and more desirably from 7,000 to 500,000; a number average molecular weight (Mn) is desirably from 2,000 to 10,000; and a molecular weight distribution Mw/Mn is desirably from 1.5 to 100, and more desirably from 2 to 60 by the molecular weight measurement of a gel permeation chromatography (GPC) method of tetrahydrofuran (THF)-soluble matter.

This weight average molecular weight is one obtained by measuring a THF-soluble matter with a THF solvent using GPC•HLC-8120, manufactured by Tosoh Corporation and a column TSKgel Super HM-M (15 cm), manufactured by Tosoh Corporation and calculating a molecular weight by using a molecular weight calibration curve prepared from a monodispersed polystyrene standard sample.

Also, a softening temperature of the binder resin is present desirably in the range of from 80° C. to 130° C., and more desirably in the range of from 90° C. to 120° C.

The softening temperature of the binder resin refers to an intermediate temperature between a melting-starting temperature and a melting completion temperature as measured by using a flow tester (CFT-500C, manufactured by Shimadzu Corporation) under conditions of preheating at 80° C./300 sec, a plunger pressure of 0.980665 MPa, a die size of 1 mmφ×1 mm and a temperature elevation rate of 3.0° C./min.

### —Coloring Agent—

The coloring agent is described.

The coloring agent may be used in an amount ranging from 2% by mass to 15% by mass among the components constituting the toner particle. The amount of the coloring agent is desirably in the range of from 3% by mass to 10% by mass.

Examples of the coloring agent include known organic or inorganic pigments or dyes and oil-soluble dyes.

Examples of black pigments include carbon black and magnetic powders.

Examples of yellow pigments include Hanza Yellow, Hanza Yellow 10G, Benzidine Yellow G, Benzidine Yellow GR, Threne Yellow, Quinoline Yellow and Permanent Yellow NCG.

Examples of red pigments include Bengara, Watchyoung Red, Permanent Red 4R, Lithol Red, Brilliant Carmine 3B, Brilliant Carmine 6B, Du Pont Oil Red, Pyrazolone Red, Rhodamine B Lake, Lake Red C, Rose Bengal, Eoxine Red and Alizarine Lake.

Examples of blue pigments include Prussian Blue, Cobalt Blue, Alkali Blue Lake, Victoria Blue Lake, Fast Sky Blue, Indanthrene Blue BC, Aniline Blue, Ultramarine Blue, Calco Oil Blue, Methylene Blue Chloride, Phthalocyanine Blue, Phthalocyanine Green and Malachite Green Oxalate.

Also, these coloring agents may be mixed or may be used in a solid solution state.

### —Release Agent—

Next, the release agent is described.

The release agent may be used in an amount ranging from 1% by mass to 10% by mass among the components constituting the toner particle. The amount of the release agent is desirably in the range of from 2% by mass to 8% by mass.

The release agent may be a substance having a main endothermic peak as measured in compliance with ASTMD 3418-8 in the range of from 50° C. to 140° C.

For the measurement of the main endothermic peak, for example, DSC-7, manufactured by PerkinElmer, Inc. is used. For the temperature correction of a detection part of this apparatus, melting temperatures of indium and zinc are used, and for the correction of heat amount, a melting heat of indium is used. An aluminum-made pan is used for a sample, an empty pan is set for control, and the measurement is performed at a temperature elevation rate of 10° C./min.

A viscosity η₁ of the release agent at 160° C. may be in the range of from 20 cps to 600 cps.

Specific examples of the release agent include low-molecular weight polyolefins such as polyethylene, polypropylene and polybutene; silicones having a softening temperature upon heating; fatty acid amides such as oleic amide, erucic amide, ricinoleic amide and stearic amide; vegetable waxes such as carnauba wax, rice wax, candelilla wax, Japan wax and jojoba oil; animal waxes such as beeswax; mineral waxes such as montan wax, ozokerite, ceresin, paraffin wax, microcrystalline wax and Fischer-Tropsch wax; petroleum waxes; and modified products thereof.

### —Other Additives—

Other additives are described.

Examples of other additives include various components such as an internal additive, a charge controlling agent, an inorganic powder (inorganic particle) and an organic particle.

Examples of the internal additive include magnetic materials such as metals (for example, ferrite, magnetite, reduced iron, cobalt, nickel, manganese, etc.) or alloys or compounds containing these metals.

Examples of the inorganic particle include known inorganic particles such as a silica particle, a titanium oxide particle, an alumina particle, a cerium oxide particle, or particles obtained by subjecting the surface of such a particle to a hydrophobic treatment. Such an inorganic particle may be subjected to a surface treatment of every kind. For example, an inorganic particle having been subjected to a surface treatment with a silane based coupling agent, a titanium based coupling agent, a silicone oil or the like may be useful.

—Characteristics—

Next, characteristics of the toner particle are described.

A volume average particle diameter D₅₀ of the toner particles is desirably in the range of from 3 μm to 9 μm, and more desirably in the range of from 3 μm to 6 μm,

Incidentally, the measurement of the volume average particle diameter is performed at an aperture size of 50 μm by using Multisizer II (manufactured by Beckman Coulter, Inc.). On that occasion, the measurement is performed after dispersing the toner particles in an electrolyte aqueous solution (ISOTON aqueous solution) and ultrasonically dispersing the solution for 30 seconds or more.

### (Preparing Method of Toner)

Next, the preparation method of the toner according to the present exemplary embodiment is described.

First of all, the toner particle may be produced by any one of a dry preparation method (for example, a kneading and pulverization method, etc.) or a wet preparation method (for example, an aggregation and coalescence method, a suspension polymerization method, a dissolution suspension granulation method, a dissolution suspension method, a dissolution emulsion polymerization coalescence method, etc.). There are no particular limitations in these methods, and well-known preparation methods are adopted.

Then, the toner according to the present exemplary embodiment is, for example, produced by adding the foregoing external additive to the resulting toner particle and mixing them. Mixing may be, for example, performed by using a V-type blender, a Henschel mixer, a Loedige mixer or the like. Furthermore, if desired, a coarse particle of the toner may be removed by using a vibration sieve, a wind force sieve or the like.

### <Electrostatic Image Developer>

The electrostatic image developer according to the present exemplary embodiment contains at least the toner according to the present exemplary embodiment.

The electrostatic image developer according to the present exemplary embodiment may be a single-component developer containing only the electrostatic image developing toner according to the present exemplary embodiment, or may be a two-component developer containing a mixture of the electrostatic image developing toner according to the present exemplary embodiment and a carrier.

The carrier is not particularly limited, and known carriers are exemplified. Examples of the carrier include a resin-coated carrier, a magnetic-dispersed carrier and a resin-dispersed carrier.

In the two-component developer, a mixing ratio (mass ratio) of the toner according to the present exemplary embodiment and the carrier is desirably in the range of from about 1/100 to about 30/100, and more desirably in the range of from about 3/100 to about 20/100 in terms of a ratio of the toner to the carrier.

### <Image Forming Apparatus>

Next, the image forming apparatus according to the present exemplary embodiment is described.

The image forming apparatus according to the present exemplary embodiment includes a latent image holding member; a charging unit for charging the surface of the latent image holding member; an electrostatic image forming unit for forming an electrostatic image on the surface of the charged latent image holding member; a developing unit accommodating an electrostatic image developer therein, which develops an electrostatic image formed on the surface of the latent image holding member with the electrostatic image developer to form a toner image; a transfer unit for transferring the toner image formed on the surface of the latent image holding member onto a transfer-receiving material; and a fixing unit for fixing the toner image transferred on the transfer-receiving material. Then, as the electrostatic image developer, the foregoing electrostatic image developer according to the present exemplary embodiment is applied.

Incidentally, in the image forming apparatus according to the present exemplary embodiment, for example, a portion including the developing unit may be of a cartridge structure (process cartridge) which is mounted detachably against the image forming apparatus, and as the process cartridge, a process cartridge including a developing unit accommodating the electrostatic image developer according to the present exemplary embodiment therein is suitably useful. Also, in this image forming apparatus, for example, a portion accommodating an electrostatic image developing toner for replenishment may be of a cartridge structure (toner cartridge) which is mounted detachably against the image forming apparatus, and as the toner cartridge, a toner cartridge accommodating the electrostatic image developer according to the present exemplary embodiment therein is suitably useful.

An example of the image forming apparatus according to the present exemplary embodiment is hereunder described, but it should not be construed that the invention is limited thereto. Incidentally, major parts shown in the drawings are described, and the description of other parts is omitted.

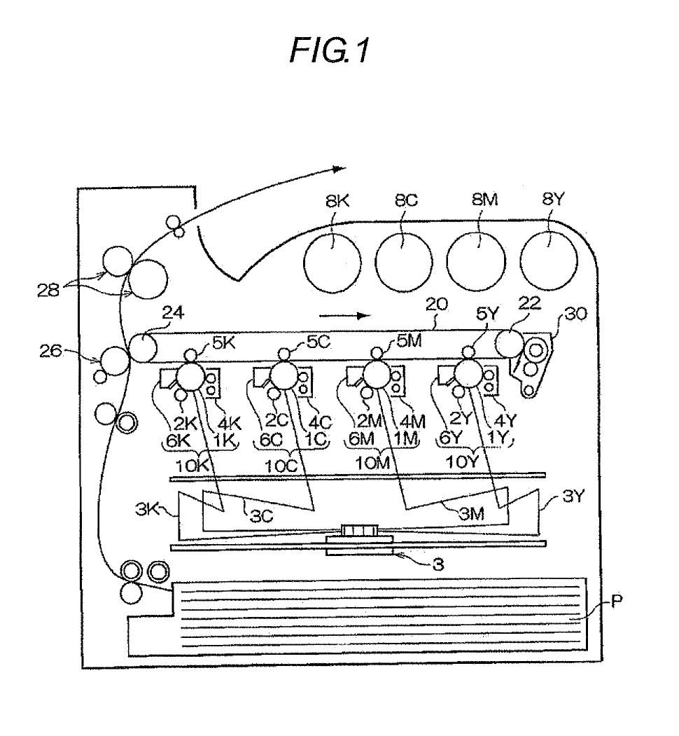

FIG. 1 is a diagrammatic configuration view showing an image forming apparatus of a quadruplet tandem mode, which is an example of the image forming apparatus according to the present exemplary embodiment. The image forming apparatus shown in FIG. 1 is provided with first to fourth electrophotographic image forming units 10Y, 10M, 10C and 10K, which output yellow (Y), magenta (M), cyan (C) and black (K) color images, respectively on the basis of color-separated image data. These image forming units (hereinafter also referred to simply as “unit” or “units”) 10Y, 10M, 10C and 10K are arranged horizontally in a line with predetermined distances therebetween. Incidentally, each of these units 10Y, 10M, 10C and 10K may be a process cartridge which is mounted detachably against the image forming apparatus main body.

An intermediate transfer belt 20 is provided as an intermediate transfer member extending above each of the units 10Y, 10M, 10C and 10K as shown in the drawings. The intermediate transfer belt 20 is provided around a drive roller 22 and a support roller 24 coming into contact with the inner surface of the intermediate transfer belt 20, which are separated from left to right as shown in the drawings. The intermediate transfer belt 20 runs in a direction from the first unit 10Y to the fourth unit 10K. Incidentally, the support roller 24 is biased in a direction of separation from the drive roller 22 by a spring or the like (not shown), such that a predetermined tension is applied to the intermediate transfer belt 20 which is provided around the support roller 24 and the drive roller 22. Also, on the surface of the image holding member side of the intermediate transfer belt 20, an intermediate transfer member cleaning device 30 is provided opposing to the drive roller 22.

Also, toners in the four colors of yellow, magenta, cyan and black, which are stored in toner cartridges 8Y, 8M, 8C and 8K, respectively, are supplied to developing devices (developing units) 4Y, 4M, 4C and 4K of the units 10Y, 10M, 10C and 10K, respectively.

Each of the foregoing first to fourth units 10Y, 10M, 10C and 10K has the same configuration. Therefore, the first unit 10Y which forms a yellow image and is provided on the upstream side in a running direction of the intermediate transfer belt 20 is representatively described herein. The components in the second to fourth units 10M, 10C and 10K are designated by letters M for magenta, C for cyan and K for black, respectively in the same manner in which the equivalent components in the first unit 10Y are indicated by Y for yellow, and the description thereof is omitted.

The first unit 10Y includes a photoreceptor 1Y functioning as a latent image holding member. In the surroundings of the photoreceptor 1Y, there are successively disposed a charge roller 2Y for charging the surface of the photoreceptor 1Y to a predetermined potential; an exposing device 3 for exposing the charged surface with a laser beam 3Y on the basis of a color-separated image signal to form an electrostatic latent image; the developing device (developing unit) 4Y for supplying a charged toner into an electrostatic latent image to develop the electrostatic latent image; a primary transfer roller 5Y (primary transfer unit) for transferring the developed toner image onto the intermediate transfer belt 20; and a photoreceptor cleaning device (cleaning unit) 6Y for removing the toner remaining on the surface of the photoreceptor 1Y after the primary transfer.

Incidentally, the primary transfer roller 5Y is disposed in the inside of the intermediate transfer belt 20 and provided at a position opposing to the photoreceptor 1Y. Furthermore, each of the primary transfer rollers 5Y, 5M, 5C and 5K is connected to a bias power source (not shown) for impressing a primary transfer bias to each of the primary transfer rollers. Each of the bias power sources is controlled by a control section (not shown) such that a transfer bias to be impressed to each of the primary transfer rollers may be changed.

An operation of forming a yellow image in the first unit 10Y is hereunder described. First of all, prior to the operation, the surface of the photoreceptor 1Y is charged to from about −600 V to about −800 V by the charge roller 2Y

The photoreceptor 1Y is formed by laminating a photosensitive layer on a conductive substrate (volume resistivity at 20° C.: not more than 1×10⁻⁶ Ωcm). Though in general, this photosensitive layer has high resistance (resistance as in general resins), it has such characteristics that when irradiated with the laser beam 3Y, a specific resistance of a portion irradiated with the laser beam changes. Then, the laser beam 3Y is outputted onto the surface of the charged photoreceptor 1Y via the exposing device 3 according to image data for yellow sent from the control section (not shown). The laser beam 3Y is irradiated on the photosensitive layer on the surface of the photoreceptor 1Y, whereby an electrostatic image having a yellow printing pattern is formed on the surface of the photoreceptor 1Y.

The electrostatic image as referred to herein is an image formed on the surface of the photoreceptor 1Y by charging and is a so-called negative latent image which is formed by the matter that the specific resistance of an irradiated portion of the photosensitive layer is lowered due to the laser beam 3Y, and a charge charged on the surface of the photoreceptor 1Y is discharged, whereas a charge in a portion not irradiated with the laser beam 3Y remains.

The electrostatic image thus formed on the photoreceptor 1Y is rotated to a predetermined developing position following running of the photoreceptor 1Y. Then, the electrostatic image on the photoreceptor 1Y is made into a visible image (toner image) by the developing device 4Y at this developing position.

The developing device 4Y stores the yellow toner according to the present exemplary embodiment. The yellow toner undergoes frictional charging upon being stirred within the developing device 4Y, has a charge with the same polarity (negative polarity) as that of a charge charged on the photoreceptor 1Y and is retained on a developer roller (developer holding member). When the surface of the photoreceptor 1Y passes through the developing device 4Y, the yellow toner electrostatically attaches to a latent image portion at which the charge is removed from the surface of the photoreceptor 1Y, and the latent image is developed with the yellow toner. The photoreceptor 1Y on which a yellow toner image is formed is subsequently made to run at a predetermined speed, and the toner image developed on the photoreceptor 1Y is conveyed to a predetermined primary transfer position.

When the yellow toner image on the photoreceptor 1Y is conveyed to the primary transfer position, a predetermined primary transfer bias is impressed to the primary transfer roller 5Y, a static electricity force directed from the photoreceptor 1Y toward the primary transfer roller 5Y acts upon the toner image, and the toner image on the photoreceptor 1Y is transferred onto the intermediate transfer belt 20. At that time, the transfer bias to be impressed has a (positive) polarity opposite to that of the toner (having a negative polarity). For example, the first unit 10Y is controlled to about +10 μA by the control section (not shown).

Meanwhile, the toner remaining on the photoreceptor 1Y is removed by the cleaning device 6Y and recovered.

Also, primary transfer biases to be impressed respectively to the primary transfer roller 5M at the second unit 10M and thereafter, the primary transfer rollers 5C and 5K are controlled similarly to the primary transfer bias of the first unit.

In this way, the intermediate transfer belt 20 having a yellow toner image transferred thereonto from the first unit 10Y is successively conveyed through the second to fourth units 10M, 10C and 10K, and toner images of respective colors are superposed and multi-transferred.

The intermediate transfer belt 20 having the four toner images multi-transferred thereonto through the first to fourth units arrives at a secondary transfer portion which is constituted of the intermediate transfer belt 20, the support roller 24 coming into contact with the inner surface of the intermediate transfer belt 20 and a secondary transfer roller (secondary transfer unit) 26 disposed on the side of the image holding surface of the intermediate transfer belt 20. Meanwhile, a recording paper (transfer-receiving material) P is supplied at a predetermined timing through a supply mechanism to a gap at which the secondary transfer roller 26 and the intermediate transfer belt 20 are brought into press contact with each other, and a predetermined secondary transfer bias is impressed to the support roller 24. At that time, the transfer bias to be impressed has a (negative) polarity identical to that of the toner (also having a negative polarity), and a static electricity force directed from the intermediate transfer belt 20 toward the recording paper P acts upon the toner image, whereby the toner image on the intermediate transfer belt 20 is transferred onto the recording paper P. Incidentally, on that occasion, the secondary transfer bias is determined depending upon a resistance detected by a resistance detecting unit (not shown) for detecting a resistance of the secondary transfer portion, and its voltage is controlled.

Thereafter, the recording paper P is sent to a fixing device (fixing unit) 28, and the toner image is heated, whereby the toner image having colors superposed thereon is melted and fixed onto the recording paper P. The recording paper P having a color image fixed thereunto is then sent to an ejection portion, whereby a series of the color image formation operations ends.

Incidentally, the above-exemplified image forming apparatus has such a configuration that a toner image is transferred onto the recording paper P via the intermediate transfer belt 20. However, it should not be construed that the invention is limited to this configuration, and the invention may also have a structure in which a toner image is transferred directly from a photoreceptor to a recording paper.

### <Process Cartridge and Toner Cartridge>

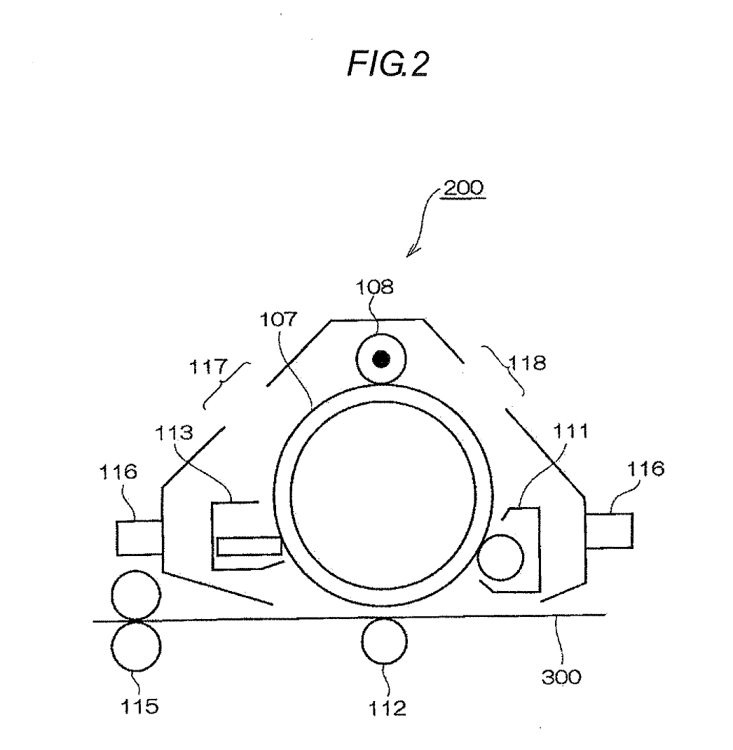

FIG. 2 is a diagrammatic configuration view showing a suitable example of a process cartridge for storing the electrostatic image developer according to the present exemplary embodiment. A process cartridge 200 includes, integrally, a charge roller 108, a photoreceptor 107, a photoreceptor cleaning device (cleaning unit) 113, an opening portion 118 for exposure and an opening portion 117 for charge removal exposure, together with a developing device 111, all of which are combined using a mounting rail 116. Incidentally, in FIG. 2, a reference numeral 300 in FIG. 2 stands for a transfer-receiving material.

Then, this process cartridge 200 is mounted freely detachably against an image forming apparatus main body constituted of a transfer device 112, a fixing device 115 and other constituent elements (not shown) and configures an image forming apparatus together with the image forming apparatus main body.

The process cartridge 200 shown in FIG. 2 is provided with the charge roller 108, the developing device 111, the cleaning device (cleaning unit) 113, the opening portion 118 for exposure and the opening portion 117 for charge erasing exposure; however, these devices may be selectively combined. The process cartridge according to the present exemplary embodiment may also be one provided with, in addition to the developing device 111, at least one member selected from the group consisting of the charge roller 108, the photoreceptor 107, the photoreceptor cleaning device (cleaning unit) 113, the opening portion 118 for exposure and the opening portion 117 for charge erasing exposure.

Next, the toner cartridge according to the present exemplary embodiment is described. The toner cartridge according to the present exemplary embodiment is mounted detachably against the image forming apparatus and is at least a toner cartridge for accommodating the toner for supply into a developing unit provided within the image forming apparatus, in which the toner is the already-described toner according to the present exemplary embodiment. Incidentally, the toner cartridge according to the present exemplary embodiment may at least accommodate a toner therein and may also accommodate, for example, a developer depending on the mechanism of the image forming apparatus. It is preferable that the electrostatic image developing toner of the invention is accommodated in 90% or more of a volume of the toner cartridge of the invention.

In consequence, in an image forming apparatus against which the toner cartridge may be mounted detachably, by utilizing a toner cartridge which accommodates the toner according to the present exemplary embodiment therein, the toner according to the present exemplary embodiment is easily supplied into a developing device.

Incidentally, the image forming apparatus shown in FIG. 1 is an image forming apparatus having a configuration in which the toner cartridges 8Y, 8M, 8C and 8K are mounted detachably, and the developing devices 4Y, 4M, 4C, and 4K are connected to toner cartridges corresponding to the respective developing devices (colors) via a toner supply line (not shown). Also, in the case where the toner accommodated in the toner cartridge runs low, the toner cartridge is exchanged.

### EXAMPLES

The present exemplary embodiment is more specifically described below with reference to the following Examples and Comparative Examples, but it should be construed that the present exemplary embodiment is not in any way limited to these Examples. Incidentally, all “parts” and “percentages” are on a mass basis unless otherwise indicated.

### Example 1

### <Preparation of Toner 1>

### (Preparation of Resin Particle Dispersion Liquid 1)

Styrene (manufactured by Wako Pure Chemical Industries, Ltd.): 320 parts
n-Butyl acrylate (manufactured by Wako Pure Chemical Industries, Ltd.): 80 parts
β-Carboxyethyl acrylate (manufactured by Rhodia Nicca, Ltd.): 9 parts
1,10-Decanediol diacrylate (manufactured by Shin Nakamura Chemical Co., Ltd.): 1.5 parts
Dodecanethiol (manufactured by Wako Pure Chemical Industries, Ltd.): 2.7 parts

To a solution obtained by mixing and dissolving the foregoing components, a solution having 4 parts of an anionic surfactant DOWFAX (manufactured by The Dow Chemical Company) dissolved in 550 parts of ion-exchanged water is added and emulsified in a flask, and 50 parts of ion-exchanged water having 6 parts of ammonium persulfate dissolved therein is further thrown over 10 minutes while gently stirring and mixing. Subsequently, after thoroughly substituting the inside of the flask with nitrogen, the solution within the flask is heated to 70° C. on an oil bath while stirring, and emulsion polymerization is continued as it is for 5 hours, thereby obtaining an anionic resin particle dispersion liquid 1 having a solids content of 41%.

The resin particle in the resin particle dispersion liquid 1 has a median particle diameter of 196 nm, a glass transition temperature of 51.5° C. and a weight average molecular weight Mw of 32,400.

### (Preparation of Resin Particle Dispersion Liquid 2)

Styrene (manufactured by Wako Pure Chemical Industries, Ltd.): 280 parts
n-Butyl acrylate (manufactured by Wako Pure Chemical Industries, Ltd.): 120 parts
β-Carboxyethyl acrylate (manufactured by Rhodia Nicca, Ltd.): 9 parts

To a solution obtained by mixing and dissolving the foregoing components, a solution having 1.5 parts of an anionic surfactant DOWFAX (manufactured by The Dow Chemical Company) dissolved in 550 parts of ion-exchanged water is added and emulsified in a flask, and 50 parts of ion-exchanged water having 0.4 parts of ammonium persulfate dissolved therein is further thrown over 10 minutes while gently stirring and mixing. Subsequently, after thoroughly substituting the inside of the flask with nitrogen, the solution within the flask is heated to 70° C. on an oil bath while stirring, and emulsion polymerization is continued as it is for 5 hours, thereby obtaining an anionic resin particle dispersion liquid 2 having a solids content of 42%.

The resin particle in the resin particle dispersion liquid 2 has a medium particle diameter of 150 nm, a glass transition temperature of 53.2° C., a weight average molecular weight Mw of 41,000 and a number average molecular weight Mn of 25,000.

### (Preparation of Coloring Agent Particle Dispersion Liquid 1)

C.I. Pigment Yellow 74 pigment: 30 parts
Anionic surfactant (NEWREX R, manufactured by NOF Corporation): 2 parts
Ion-exchanged water: 220 parts

The foregoing components are mixed and preliminary dispersed for 10 minutes by a homogenizer (IKA ULTRA-TURRAX), and thereafter, the resulting dispersion is further subjected to a dispersion treatment for 15 minutes at a pressure of 245 MPa using ULTIMAIZER (a high-pressure counter collision disperser, manufactured by Sugino Machine Limited), thereby obtaining a coloring agent particle dispersion liquid 1 having a central particle diameter of coloring agent particle of 169 nm and a solids content of 22.0%.

### (Preparation of Release Agent Particle Dispersion Liquid 1)

Paraffin wax HNP9 (melting temperature: 75° C., manufactured by Nippon Seiro Co., Ltd.): 45 parts
Cationic surfactant NEOGEN RK (manufactured Dai-ichi Kogyo Seiyaku Co., Ltd.): 5 parts
Ion-exchanged water: 200 parts

The foregoing components are mixed and heated at 100° C., and the resulting mixture is thoroughly dispersed using IKA's ULTRA-TURRAX T50. Thereafter, the resulting dispersion is further subjected to a dispersion treatment using a pressure discharge type Gaulin homogenizer, thereby obtaining a release agent particle dispersion liquid 1 having a central particle diameter of release agent particle of 196 nm and a solids content of 22.0%.

### (Preparation of Toner Particle)

Resin particle dispersion liquid 1: 106 parts
Resin particle dispersion liquid 2: 36 parts
Coloring agent particle dispersion liquid 1: 30 parts
Release agent particle dispersion liquid 1: 91 parts

The foregoing components are thoroughly mixed and dispersed in a round bottom stainless steel-made flask by using ULTRA-TURRAX T50, thereby obtaining a solution.

Subsequently, 0.4 parts of polyaluminum chloride is added to this solution to prepare a core aggregated particle, and the dispersion operation is continued by using ULTRA-TURRAX. Furthermore, the solution within the flask is heated to 49° C. on an oil bath for heating, and after keeping it at 49° C. for 60 minutes, 36 parts of the resin particle dispersion liquid 1 is gently added thereto, thereby preparing a core/shell aggregated particle. Thereafter, after a pH of the solution is adjusted to 5.6 by the addition of 0.5 mol/L of a sodium hydroxide aqueous solution, the stainless steel-made flask is hermetically sealed, and the solution is heated to 96° C. while continuing stirring using a magnetic force seal. After keeping for 5 hours, the resulting solution is cooled to obtain a yellow toner particle.

Subsequently, the toner particle in a state where it is dispersed in the solution is filtered and thoroughly washed with ion-exchanged water, followed by solid-liquid separation by means of Nutsche type suction filtration. This is further redispersed in 3 L of ion-exchanged water at 40° C. and stirred and washed at 300 rpm for 15 minutes. This operation is further repeated five times, and when the filtrate has a pH of 7.01, an electric conductivity of 9.8 μS/cm and a surface tension of 71.1 Nm, solid-liquid separation is performed using a No. 5A filter paper by means of Nutsche type suction filtration. The resulting solid is dried in vacuo over 12 hours, thereby obtaining a toner particle having an average particle diameter of 6.4 μm.

### (Preparation of External Additive 1)

### —Alkaline Catalyst Solution Preparing Step [Preparation of Alkaline Catalyst Solution (1)]—

In a glass-made reaction vessel having a volume of 3 L and equipped with a metal-made stirring blade, a dropping nozzle (micro tube pump made of Teflon (a registered trademark)) and a thermometer, 600 parts of methanol and 125 parts of 10% ammonia water are charged and mixed with stirring to obtain an alkaline catalyst solution (1). At that time, an ammonia catalyst amount, i.e., an NH₃ amount in the alkaline catalyst solution (1) (NH₃ [mol]/(ammonia+methanol) [L]) is 0.83 mol/L.

### —Particle Forming Step [Preparation of Silica Particle Suspension (1)]—

Subsequently, a temperature of the alkaline catalyst solution (1) is adjusted to 25° C., and the alkaline catalyst solution (1) is substituted with nitrogen. Thereafter, dropwise addition of 120 parts of tetramethoxysilane (TMOS) and 107 parts of ammonia water having a catalyst (NH₃) concentration of 4.4% in the following supply amounts is simultaneously started while stirring the alkaline catalyst solution (1), thereby obtaining a suspension of the silica particle (silica particle suspension (1)).

Here, the supply amount of tetramethoxysilane (TMOS) is set to 10.1 g/min, namely 0.0035 mol/(mol·min) relative to a total molar number of methanol in the alkaline catalyst solution (1).

Also, the supply amount of the 4.4% ammonia water is set to 4.2 glmin relative to a total supply amount of the tetraalkoxysilane to be supplied per minute (0.0664 mol/min). This is corresponding to 0.35 mol/min per mole of the total supply amount of the tetraalkoxysilane to be supplied per minute.

### —Hydrophobic Treatment of Silica Particle—

200 parts (solids content: 13.985%) of the silica particle suspension (1) is subjected to a hydrophobic treatment by the addition of 5.59 parts of trimethylsilane. Thereafter, the resultant is dried upon heating at 65° C. using a hot plate, thereby forming a hydrophobic silica particle (1) in a heterogeneous shape.

This hydrophobic silica particle (1) is designated as an external additive 1.

The resulting external additive 1 is measured with respect to the volume average particle diameter, average circularity and standard deviation of circularity in the foregoing methods. The results are shown in Table 2.

### (Preparation of External Additives 2 to 11)

The same procedures as those in the preparation of Example 1 are followed, except that in the alkaline catalyst solution preparing step, the methanol amount and the 10% ammonia water amount are changed to amounts as shown in Table 1. The NH₃ amount is shown in the column of “10% ammonia water” in Table 1.

The same procedures as those in the preparation method of the external additive 1 of Example 1 are followed, except that in the preparation of the silica particle suspension, the foregoing alkaline catalyst solution is used, and the amount and supply amount of tetramethoxysilane (TMOS) to be added to the alkaline catalyst solution and the concentration, amount and supply amount of the catalyst (NH₃) of ammonia water to be added to the alkaline catalyst solution are changed to values as shown in Table 1.

The amount and supply amount of tetramethoxysilane to be added in the alkaline catalyst solution are changed to a mass value shown in the column of “TMOS” of “Total addition amount” in Table 1, and the supply amount of tetramethoxysilane is changed to an amount shown in the column of “TMOS” of “Supply amount (g/min)” in Table 1.

The catalyst (NH₃) concentration, amount of supply amount of the ammonia water to be added to the alkaline catalyst solution are changed to an amount shown in the column of “NH₃ concentration” of “Ammonia water” of “Total addition amount” in Table 1; the amount of ammonia water is changed to an amount shown in the column of “Mass parts” of “Ammonia water” of “Total addition amount” in Table 1; and the supply amount of ammonia water is changed to an amount shown in the column of “Ammonia water (g/min)” of “Supply amount” in Table 1.

Here, some of the supply amounts of TMOS are described in the column of “TMOS amount” of “Supply amount (relative amount)” relative to a total molar number of methanol in the alkaline catalyst solution, respectively. Also, some of the supply amounts of ammonia water are described in the column of “NH₃ amount” of “Supply amount (relative amount)” per mole of a total supply amount of tetramethoxysilane to be supplied per minute, respectively.

The hydrophobic treatment and drying are performed in the same manner as in the preparation method of the external additive 1 in Example 1.

### (Preparation of Toner 1)

2.0 parts of the external additive 1 is added to 100 parts of the toner particle using a Henschel mixer, thereby preparing a toner 1.

With respect to the resulting toner 1, an image analysis is performed in the foregoing method. As a result, the external additive (silica particle) has a volume average particle diameter of 75 run, an average circularity of 0.85 and a standard deviation of circularity of 0.15.

### <Preparation of Carrier>

Ferrite particle (average particle diameter: 50 μm): 100 parts
Toluene: 14 parts
Styrene-methyl acrylate copolymer (component ratio: 90/10): 2 parts
Carbon black (R330, manufactured by Cabot Corporation): 0.2 parts

First of all, the foregoing components exclusive of the ferrite particle are stirred for 10 minutes by using a stirrer to prepare a dispersed coating solution. Subsequently, this coating solution and the ferrite particle are charged into a vacuum deaeration type kneader and stirred at 60° C. for 30 minutes. Thereafter, the resultant is further deaerated under reduced pressure and dried while heating, thereby preparing a carrier.

### <Preparation of Developer>

4 parts of the toner 1 and 96 parts of the carrier are stirred at 40 rpm for 20 minutes using a V-type blender and sieved with a sieve having an opening of 250 μm, thereby preparing a developer.

### <Evaluation>

The resulting developer is evaluated in the following manner. The results are shown in Table 2.

The resulting developer is accommodated in a developing machine of an image forming apparatus DocuCentre Color 400 (manufactured by Fuji Xerox Co., Ltd.). An OHP sheet is stuck onto a top of the developing machine of the image forming apparatus; printing of an image having an image density of 25% on an A4-sized paper is performed on 150,000 sheets in a 10% RH environment at 10° C. (low-temperature and low-humidity environment) and an 80% RH environment at 28° C. (high-temperature and high-humidity environment), respectively; and after printing of 150,000 sheets, an amount of the toner deposited on the OHP sheet is determined through visual inspection. The obtained results are shown in Table 2.

### —Evaluation Criteria—

A: Toner contamination cannot be observed through visual inspection.

B: The toner attaches a little.

C: The toner entirely attaches.

### Example 2

A developer is prepared in the same manner as in Example 1, except that the external additive 1 of Example 1 is replaced by the external additive 2 shown in the following Table 1, and this developer is evaluated in the same manner as in Example 1. The results are shown in Table 2.

### Example 3

A developer is prepared in the same manner as in Example 1, except that the external additive 1 of Example 1 is replaced by the external additive 3 shown in the following Table 1, and this developer is evaluated in the same manner as in Example 1. The results are shown in Table 2.

### Example 4

A developer is prepared in the same manner as in Example 1, except that the external additive 1 of Example 1 is replaced by the external additive 4 shown in the following Table 1, and this developer is evaluated in the same manner as in Example 1. The results are shown in Table 2.

### Comparative Example 1

A developer is prepared in the same manner as in Example 1, except that the external additive 1 of Example 1 is replaced by the external additive 5 shown in the following Table 1, and this developer is evaluated in the same manner as in Example 1. The results are shown in Table 2.

### Comparative Example 2

A developer is prepared in the same manner as in Example 1, except that the external additive 1 of Example 1 is replaced by the external additive 6 shown in the following Table 1, and this developer is evaluated in the same manner as in Example 1. The results are shown in Table 2.

### Comparative Example 3

A developer is prepared in the same manner as in Example 1, except that the external additive 1 of Example 1 is replaced by the external additive 7 shown in the following Table 1, and this developer is evaluated in the same manner as in Example 1. The results are shown in Table 2.

### Comparative Example 4

A developer is prepared in the same manner as in Example 1, except that the external additive 1 of Example 1 is replaced by the external additive 8 shown in the following Table 1, and this developer is evaluated in the same manner as in Example 1. The results are shown in Table 2.

### Comparative Example 5

A developer is prepared in the same manner as in Example 1, except that the external additive 1 of Example 1 is replaced by the external additive 9 shown in the following Table 1, and this developer is evaluated in the same manner as in Example 1. The results are shown in Table 2.

### Comparative Example 6

A developer is prepared in the same manner as in Example 1, except that the external additive 1 of Example 1 is replaced by the external additive 10 shown in the following Table 1, and this developer is evaluated in the same manner as in Example 1. The results are shown in Table 2.

### Comparative Example 7

A developer is prepared in the same manner as in Example 1, except that the external additive 1 of Example 1 is replaced by the external additive 11 shown in the following Table 1, and this developer is evaluated in the same manner as in Example 1. The results are shown in Table 2.

TABLE 1

| | Preparing step | | | Particle forming step | | | | | | |
|---|---|---|---|---|---|---|---|---|---|---|
| | Components to be added | | | Total addition amount | | | | | | |
| | | 10% ammonia water | | | Ammonia water | | Supply amount (g/min) | | Supply amount (relative amount) | |
| | Methanol | | NH₃ | TMOS | | NH₃ | | Ammonia | NH₃ amount | TMOS amount |
| | Parts by | Parts by | amount | Parts by | Parts by | concentration | TMOS | water | (mol/min) | (mol/(mol · min)) |
| | mass | mass | (mol/L) | mass | mass | (%) | (g/min) | (g/min) | (vs. TMOS) | (vs. methanol) |
| External | 600 | 125 | 0.83 | 120 | 107 | 4.4 | 10.1 | 4.2 | 0.35 | 0.0035 |
| additive 1 | | | | | | | | | | |
| External | 600 | 96 | 0.66 | 400 | 224 | 4.4 | 8 | 4 | 0.22 | 0.0028 |
| additive 2 | | | | | | | | | | |
| External | 600 | 88 | 0.61 | 620 | 252 | 4.4 | 7.1 | 3.9 | 0.16 | 0.0025 |
| additive 3 | | | | | | | | | | |
| External | 600 | 93 | 0.64 | 420 | 321 | 4.4 | 6.6 | 4.3 | 0.30 | 0.0023 |
| additive 4 | | | | | | | | | | |
| External | 600 | 129 | 0.85 | 90 | 83 | 4.4 | 11.7 | 4.3 | 0.36 | 0.0041 |
| additive 5 | | | | | | | | | | |
| External | 600 | 88.5 | 0.61 | 700 | 215 | 4.4 | 6.6 | 3.8 | 0.12 | 0.0023 |
| additive 6 | | | | | | | | | | |
| External | 600 | 154 | 0.99 | 390 | 497 | 4.4 | 8 | 7.5 | 0.50 | 0.0040 |
| additive 7 | | | | | | | | | | |
| External | 600 | 98 | 0.67 | 430 | 415 | 4.4 | 16.6 | 5 | 0.38 | 00059 |
| additive 8 | | | | | | | | | | |
| External | 600 | 89 | 0.61 | 405 | 83 | 4.4 | 3.2 | 3.7 | 0.08 | 0.0011 |
| additive 9 | | | | | | | | | | |
| External | 600 | 138 | 0.90 | 380 | 115 | 4.4 | 15.1 | 3.5 | 0.12 | 0.0053 |
| additive 10 | | | | | | | | | | |
| External | 600 | 147 | 0.95 | 385 | 413 | 4.4 | 17.4 | 4 | 0.42 | 0.0061 |
| additive 11 | | | | | | | | | | |

TABLE 2

| | | | | In-apparatus | In-apparatus |
|---|---|---|---|---|---|
| | | | Standard | contamination | contamination |
| | Volume average | Average | deviation of | (Low-temperature | (High-temperature |
| | diameter (nm) | circularity | circularity | and Low-humidity) | and high-humidity) |
| Example 1 | 75 | 0.85 | 0.15 | A | A |
| Example 2 | 212 | 0.75 | 0.14 | A | A |
| Example 3 | 395 | 0.60 | 0.19 | A | A |
| Example 4 | 234 | 0.88 | 0.14 | A | A |
| Comparative | 60 | 0.88 | 0.13 | A | C |
| Example 1 | | | | | |
| Comparative | 430 | 0.57 | 0.17 | B | C |
| Example 2 | | | | | |
| Comparative | 220 | 0.95 | 0.10 | B | C |
| Example 3 | | | | | |
| Comparative | 230 | 0.75 | 0.24 | B | C |
| Example 4 | | | | | |
| Comparative | 208 | 0.45 | 0.19 | C | C |
| Example 5 | | | | | |
| Comparative | 191 | 0.55 | 0.33 | B | C |
| Example 6 | | | | | |
| Comparative | 189 | 0.93 | 0.25 | B | C |
| Example 7 | | | | | |

While the present invention has been shown and described with reference to certain exemplary embodiments thereof, it will be understood by those skilled in the art that various changes modifications may be made therein without departing from the spirit and scope of the present invention as defined by the appended claims.

What is claimed is:

1. An electrostatic image developing toner comprising:
a toner particle containing a coloring agent and a binder resin; and
an external additive on the toner particle, having a volume average particle diameter of from 70 nm to 400 nm, an average circularity of from 0.5 to 0.9 and a standard deviation of circularity of not more than 0.2.

2. The electrostatic image developing toner according to claim 1,
wherein the external additive has a volume average particle diameter of from 140 nm to 300 nm.

3. The electrostatic image developing toner according to claim 1,
wherein the external additive has an average circularity of from 0.60 to 0.85.

4. An electrostatic image developer comprising:
the electrostatic image developing toner according to claim 1; and
a carrier.

5. The electrostatic image developer according to claim 4,
wherein the external additive has a volume average particle diameter of from 140 nm to 300 nm.

6. The electrostatic image developer according to claim 4,
wherein the external additive has an average circularity of from 0.60 to 0.85.

7. A toner cartridge accommodating the electrostatic image developing toner according to claim 1 therein.

8. The toner cartridge according to claim 7,
wherein the electrostatic image developing toner according to claim 1 is accommodated in 90 vol % or more relative to a volume of the toner cartridge.

9. A process cartridge, comprising a developing unit containing the electrostatic image developer according to claim 4 so as to form a toner image by developing an electrostatic latent image formed on a surface of a latent image holding member with the electrostatic image developer.

10. An image forming apparatus comprising:
a latent image holding member;
a charging unit for charging a surface of the latent image holding member;
an electrostatic image forming unit for forming an electrostatic image on the surface of the charged latent image holding member;
a developing unit accommodating the electrostatic image developer according to claim 4 therein, which develops the electrostatic image formed on the surface of the latent image holding member with the electrostatic image developer to form a toner image;
a transfer unit for transferring the toner image formed on the surface of the latent image holding member onto a transfer-receiving material; and
a fixing unit for fixing the toner image transferred on the transfer-receiving material.

11. The image forming apparatus according to claim 10,
wherein the external additive included in the electrostatic image developer has an average circularity of from 0.60 to 0.85.

12. The image forming apparatus according to claim 10,
wherein the external additive included in the electrostatic image developer has a volume average particle diameter of from 140 nm to 300 nm.

13. An image forming method comprising:
charging a surface of a latent image holding member;
forming an electrostatic image on the surface of the latent image holding member;
developing the electrostatic image formed on the surface of the latent image holding member with the electrostatic image developer according to claim 4 to form a toner image;
transferring the toner image formed on the surface of the latent image holding member onto a transfer-receiving material; and
fixing the toner image transferred on the transfer-receiving material.

14. The image forming method according to claim 13,
wherein the electrostatic image developer contains an electrostatic image developing toner having an external additive, and
the external additive has an average circularity of from 0.60 to 0.85.

15. The image forming method according to claim 13,
wherein the electrostatic image developer contains an electrostatic image developing toner having an external additive, and
the external additive has a volume average particle diameter of from 140 nm to 300 nm.
